(19) United States
(12) Patent Application Publication
(10) Pub. No.: US 2023/0421690 A1
(43) Pub. Date: Dec. 28, 2023

(54) PROCESSING INCOMING CALLS WHILE IN A DRIVING MODE

(71) Applicant: Microsoft Technology Licensing, LLC, Redmond, WA (US)

(72) Inventor: Tapas Kumar SARKAR, Hyderabad (IN)

(21) Appl. No.: 17/851,471

(22) Filed: Jun. 28, 2022

(51) Int. Cl. H04M 1/72463; H04W 8/22; H04W 4/12; H04W 4/02; H04M 1/72469

(52) U.S. Cl. CPC H04M 1/72463; H04W 8/22; H04W 4/12; H04W 4/027; H04M 1/72469

(57) ABSTRACT

The present disclosure relates to engaging a driving mode on a client device (e.g., a mobile device) and implementing instructions of a driving mode configuration to process incoming calls received while engaged in the driving mode. The systems described herein enable a user to respond to an incoming call while driving or otherwise traveling without significantly decreasing the safety of the user or other users in a vehicle while driving. For example, driving mode management system can selectively engage the driving mode based on a combination of observed signals indicative of the user driving and having a desire to auto-reply to any received calls. The driving mode management system may additional provide a low-distraction mechanism that enables the user to generate and transmit a text message that may include text as well as a time that the user is expected to be available.

### BACKGROUND

Recent years have seen a significant increase in the use of computing devices, and particularly mobile devices, to communicate with other individuals. These mobile devices typically communicate over cellular networks, which are generally distributed over geographical areas that include base stations, core networks, and edge networks that collectively provide services and coverage to mobile devices (and other end-user devices). These devices of the cellular network provide reliable access to data networks and enable individuals to communicate over wide geographic areas and while traveling to and from various locations.

As mobile devices have become increasingly convenient and as cellular networks have made it possible to use mobile devices across a wide range of geographic areas, a number of problems have arisen with respect to environments in which users can become distracted and cause safety concerns. Indeed, as mobile devices are used more frequently while driving, distracted drivers have inadvertently caused many accidents, which can cause significant injury and damage to both individuals and property.

Many mobile device manufacturers and mobile applications have attempted to reduce these distractions. For example, many devices and applications have implemented call-blocking mechanisms that prevent a user from receiving and/or answering calls over some period of time. Other applications have provided pre-populated text options that can be selected with minimal user input. While helpful at reducing distractions, these approaches are often inflexible. For example, simply blocking calls typically does not provide any indication or information to a caller about why their call is not getting through. Moreover, pre-populated messages are often limited to a select few broadly applicable messages that similarly fail to communicate a desired message to an intended recipient.

These and other problems exist in connection processing incoming calls while a user is driving or otherwise engaged activity that prevents them from safely answering a call.

### BRIEF DESCRIPTION OF THE DRAWINGS

FIG. 1 illustrates an example block diagram of a mobile device having a driving mode management system implemented thereon in accordance with one or more embodiments.

FIG. 2 illustrates an example series of acts for engaging a driving mode and handling an incoming call in accordance with one or more embodiments.

FIGS. 3A-3B illustrate example graphical user interfaces for presenting interactive icons related to handling an incoming call in accordance with one or more embodiments.

FIGS. 4A-4B illustrates additional graphical user interfaces for presenting interactive icons related to handling an incoming call in accordance with one or more embodiments.

FIG. 5 illustrates an example series of acts for engaging and implementing a driving mode in accordance with one or more embodiments.

FIG. 6 illustrates certain components that may be included within a computer system.

### DETAILED DESCRIPTION

The present disclosure relates to systems, methods, and computer readable media for processing incoming communications to a client device (e.g., a mobile device) while a driving mode configuration is currently activated on the client device. In particular, one or more embodiments described herein involve a driving mode management system that reduces distractions for a user who is driving or otherwise engaged in an activity that restricts their ability to handle an incoming call from an originating device (e.g., a sender of the incoming communication). For example, as will be described in further detail below, a driving mode management system may provide features and functionality related to configuring a client device to reply to an incoming call in a way that allows for flexibility and customization in how an individual user responds to the incoming call. The driving mode management system may additionally be implemented in a way that can be integrated in the current framework of an operating system of the mobile device and in a way that does not use excessive computing or limited bandwidth resources on the client device.

As an illustrative example, and as will be discussed in further detail herein, the driving mode management system may implement a method for responding to incoming communications by a client device (e.g., a mobile device) while in a transit environment (e.g., while driving). The driving mode management system may engage a driving mode associated with an estimated movement of the client device. Once the driving mode is engaged, in response to detecting an incoming voice communication from a sender device, the driving mode management system may generate a text response to the incoming voice communication based on instructions of a driving mode configuration implemented (and engaged) on the client device. The driving mode management system may transmit the text response in accordance with the driving mode configuration.

The present disclosure provides a number of practical applications that provide benefits and/or solve problems associated with processing incoming communications while a user is driving or otherwise unable to answer an incoming call. By way of example and not limitations, some of these benefits will be discussed in further detail below.

For example, features and functionality of the driving mode management system provide a variety of customizable options for handling or otherwise processing an incoming call while engaged in a driving mode. As a first example, the driving mode management system can generate and send a text message that is customizable and predetermined prior to receiving an incoming call. For instance, a user can specify a message to send, which can include a pre-composed message as well as an indication of a specific time that the user of the client device is predicted to be available.

As another example, in addition to or as an alternative to sending a precomposed message, the driving mode management system can initiate recording of a voice message from the user without requiring tactile or otherwise active interaction of the user with the mobile device. Similar to the precomposed messages, recording a voice message is flexible and a favorable alternative to conventional systems, which provide a set of selectable options associated with fixed messages that can be sent in response to any incoming call as an alternative to answering the call.

In addition to providing a customizable option for replying via a voice message, the driving mode management system may record the voice message to be translated to a text message prior to delivery of the reply message to the sender device. Generating and transmitting a text message, rather than a voice message, can reduce the expense of limited bandwidth resources available to the client device while the client device is in transit. Reducing use of bandwidth in this manner is particularly beneficial when a client device is moving between geographic locations, such as between coverage areas of different base stations or in less populated areas that have limited access to cellular network resources.

This is additionally beneficial when communicating in fifth generation (5G) environments and beyond, as 5G environments provide features and functionality that enable computing devices to send electronic communications using data network components of a cellular network. Indeed, where conventional devices may be limited to preparing voicemails or SMS messages and transmitting those messages when cell coverage becomes available (and consuming valuable and often limited bandwidth resources), 5G capable devices can generate and send text messages in accordance with features and functionalities described herein when a mobile device is in transit so long as radio access network (RAN), edge network(s), and other cellular network components are within range of the mobile device. By utilizing components of 5G networks and/or future wireless network generations, the systems described herein can provide additional flexibility in transmitting those electronic messages via a variety of applications and using a variety of communication formats.

The driving mode management system may further provide the features and functionalities described herein without interrupting normal operation of the client device. For example, in one or more embodiments, the driving mode management system selectively activates the driving mode handling procedures based on both (1) determining that the client device is engaged in a driving mode and (2) verifying that the client device is likely in transit (e.g., based on detected movement and/or based on running a navigation application on the client device). This initiation of the driving mode procedures may reduce unnecessary interruption of incoming calls that could otherwise be handled safely by a user of the client device.

In addition, the driving mode management system may provide the herein-described features and functionalities within an existing framework of the client device on which the driving mode management system is implemented. For example, the driving mode management system can leverage global positioning system (GPS) capabilities of the client device to determine whether a user is driving prior to initiating the driving mode answering mechanisms. In addition, the driving mode management system may implement timing elements of the corresponding features to fit within the normal answering framework of the client device, such as a predetermined time that the client device is configured to allow an incoming call to ring prior to routing the call to voice mail or rejecting the call.

Moreover, the driving mode management system provides additional features that allow a user to safely interact with a graphical user interface (GUI) on the client device to activate one or more of the herein described features. For example, in one or more embodiments, the driving mode management system provides a large interactive icon that takes up a substantial portion of the displayable area and can be selected with minimal distraction to a driver. As another example, in one or more embodiments, the driving mode management system may provide an overlay icon that enables the user to select the icon without looking at the GUI and while preventing a user from inadvertently interacting with icons that a user does not intend to interact with while driving.

As illustrated in the foregoing discussion, the present disclosure utilizes a variety of terms to describe features and advantages of one or more embodiments of a driving mode management system described herein. Additional detail will now be provided regarding the meaning of some of these terms.

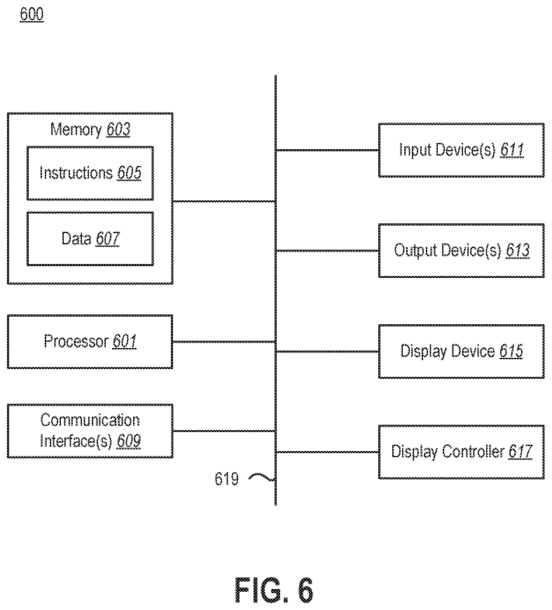

For example, as used herein, a “client device” or “computing device” may refer to any type of electronic device capable of sending and receiving text and/or voice communications over a cellular network. In one or more embodiments, the client device refers specifically to a mobile device such as a mobile telephone, a smart phone, a personal digital assistant (PDA), a tablet, a laptop, or a wearable computing device. In one or more embodiments described herein, a client device refers to a mobile device having a touch screen interface whereupon selectable icons can be presented and selected by a user of the client device. Indeed, as will be discussed in connection with one or more embodiments described herein, a client device may present one or more interactive icons that, when selected, prompt execution of instructions associated with processing or otherwise handling an incoming call from another client device (e.g., another mobile device). Additional detail in connection with an example computing device that may refer to an example client device is discussed below in connection with FIG. 6.

As used herein, a “driving mode” may refer to a mode of operation of the client device in which a specific set of instructions are executed with regard to processing incoming calls originating from other devices. For example, when a client device is engaged in driving mode, the client device may operate in accordance with instructions of a driving mode configuration that indicate certain scripts or behaviors that are invoked in response to receiving a communication (e.g., a voice or text communication) from another client device.

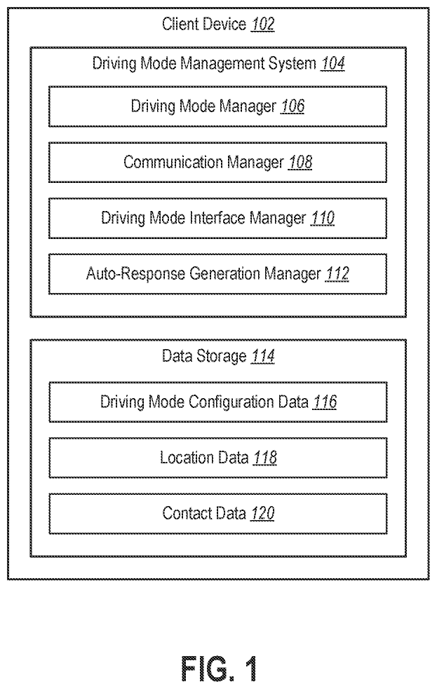

Additional detail will now be provided regarding a driving mode management system in accordance with one or more example implementations. For example, FIG. 1 illustrates an example implantation of a client device 102 having a driving mode management system 104 implemented thereon. As noted above, the client device 102 may refer to a mobile device, such as a smart phone, having a touch screen interface thereon that enables a user of the client device to deliver input commands to the client device 102 in accordance with one or more embodiments.

In one or more embodiments, the client device 102 is configurated to operate in a 5G network architecture. For example, the client device 102 may be implemented in a 5G system in which network management is software driven and network functions and resources are virtualized at the edges within a network core environment. Thus, in one or more embodiments described herein, a driving mode management system 104 may be provided via cloud-native applications, virtualized network functions, and micro-services-based design patterns.

Indeed, while one or more embodiments described herein may refer to a client device 102 that is implemented as a mobile device having similar features as other conventional mobile or smart devices, in one or more embodiments, the client device 102 may refer to an Internet of Things (IoT) device, mobile device, wearable device, or any other computing device capable of transmitting and/or receiving messages that are transmitted over a 5G communication network or future generation networks, including any network architecture capable of providing cloud computing services on the computing device.

As shown in FIG. 1, the driving mode management system 104 may include a driving mode manager 106. As will be discussed in further detail below, the driving mode manager 106 may identify when and how the client device 102 engages a driving mode in handling incoming communications originating from other devices. As noted above, when a driving mode is engaged the client device 102 may handle incoming calls in accordance with instructions from a driving mode configuration, which may include different actions that the client device 102 takes in response to receiving an incoming call. Examples of signals and factors that cause the client device 102 to engage in a driving mode will be discussed in further detail below.

As further shown in FIG. 1, the driving mode management system 104 may include a communication manager 108. As will be discussed in further detail below, the communication manager 108 may manage how incoming calls are handled as well as how the client device 102 responds to the incoming calls. In one or more embodiments, the communication manager 108 may handle incoming calls and associated responses differently based on specific instructions for the client device 102 indicated within a driving mode configuration.

As shown in FIG. 1, the driving mode management system 104 may additionally include a driving mode interface manager 110. As will be discussed in further detail herein, the driving mode interface manager 110 may provide an interface including interactive icons that enable a user to respond to an incoming call the client device 102 is engaged in a driving mode. The driving mode interface manager 110 may provide a variety of different interactive icons that allow a user to influence how the client device 102 responds to an incoming message as well as the content of the message delivered while engaged in the driving mode.

As further shown, the driving mode management system 104 may include an auto-response generation manager 112. In one or more embodiments described herein, the auto-response generation manager 112 may generate an automatic response based on detecting an incoming communication while the client device 102 is engaged in the driving mode. As will be discussed in connection with different examples below, the auto-response generation manager 112 may automatically generate and deliver a text message that includes an indication that a user of the client device 102 is driving in addition to an indication of when the user is predicted to be available. In one or more embodiments, based on the client device operating in a driving mode and in accordance with instructions from the driving mode configuration, the auto-response generation manager 112 may initiate recording of a voice message that is translated into a text message and delivered to a target device.

Each of the components 108-112 of the driving mode management system 104 may utilize data stored or otherwise accessible to the client device 102. For example, as shown in FIG. 1, the client device 102 may include a data storage 114 having a variety of data thereon which may be used by the respective components 108-112 to perform features and functionalities described herein.

For example, as shown in FIG. 1, the data storage 114 may include driving mode configuration data 116. The driving mode configuration data 116 may include any data associated with a driving mode configuration implemented on a client device 102. For example, the driving mode configuration data 116 may include instructions for determining whether the client device 102 has initiated or is otherwise engaged in a driving mode. This may include criteria, such as whether a driving mode icon is selected, whether the client device 102 is moving, or any other information that may be used to determine whether the client device 102 has engaged a driving mode.

In addition to information associated with whether the client device 102 is engaged in a driving mode, the driving mode configuration data 116 may include any data associated with instructions for how the client device 102 should process an incoming communication while engaged in the driving mode. For example, the driving mode configuration data 116 may include any script or set of instructions associated with generating a message, what text to use in populating the message, and whether to automatically send the message or await confirmation from a user of the client device 102. Indeed, it will be appreciated that the driving mode configuration data 116 may include any data or instruction that is executable by the client device 102 to perform features and functionalities described herein.

As further shown in FIG. 1, the data storage 114 may include location data 118. The location data 118 may include any information associated with a current or predicted location of the client device 102. For example, in one or more embodiments, the location data 118 may indicate a current location of the client device 102 as determined by a GPS locator on the client device 102. In one or more embodiments, the location data 118 may indicate a location of the client device 102 as determined by a position of the client device 102 with respect to radio access network (RAN) components, edge network locations from a private cellular network, or other component of a 5G network environment.

In one or more embodiments, the location data 118 may refer to a predicted location, such as a location indicated on a calendar or schedule on or accessible to the client device 102. In one or more embodiments, the location data 118 may refer to previous location, or historical locations, which may be used to predict a location over some period of time. For instance, as will be discussed in one or more implementations, the driving mode management system 104 may consider a predicted location in determining an estimated availability of the user of the client device 102 at some future time.

As further shown in FIG. 1, the data storage 114 may include contact data 120. The contact data 120 may include any information about contacts (e.g., senders, recipients associated with client devices) known to the user or otherwise saved on the client device 102. In one or more embodiments described herein, the driving mode management system 104 may consider an identity of a caller (e.g., a contact associated with a client device that is transmitting an incoming message) in determining how to specifically process a voice communication originating from the caller's device.

The components 106-112 of the driving mode management system 104 and the data storage 114 may include software, hardware, or both. For example, the components 106-112 of the driving mode management system 104 may include one or more instructions stored on a computer-readable storage medium and be executable by processors of one or more computing devices. When executed by the one or more processors, the computer-executable instructions of the device(s) can cause the client device 102 to perform the methods described herein. Alternatively, the components of the driving mode management system 104 can comprise hardware, such as a special-purpose processing device to perform a certain function or group of functions. Additionally, or alternatively, the components of the driving mode management system 104 can include a combination of computer-executable instructions and hardware.

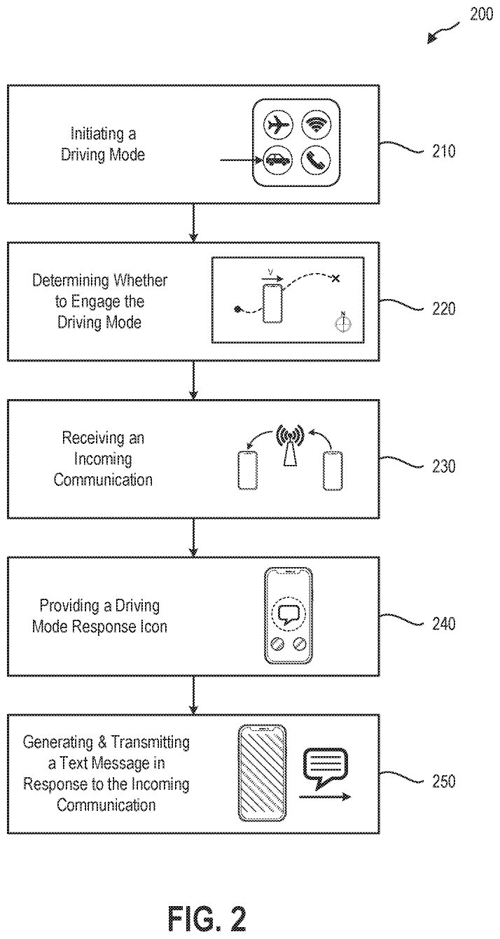

Additional detail in connection with the components 108-112 of the driving mode management system 104 will be discussed in connection with an example series of acts that may be performed by the driving mode management system 104 in processing incoming communications while the client device 102 is engaged in a driving mode. It will be appreciated that the series of acts 200 discussed in connection with FIG. 2 is provided by way of example and may include additional steps and specific features that are not necessarily implemented by each and every implementation of the driving mode management system 104. Indeed, one or more features may be omitted, or performed in a different order without limiting the scope of the embodiments described herein.

As shown in FIG. 1, the driving mode management system 104 may refer to a system that is implemented in whole or in part on a single client device 102. For example, the driving mode management system 104 may be fully implemented within or in conjunction with an existing operating system (OS) running on a mobile device. Alternatively, one or more components (e.g., components 106-114) may be implemented on a cloud computing system, such as on an edge network that provides cellular network capabilities (e.g., of a 5G networking architecture) to the client device 102. For instance, one or more features of the driving mode management system 104 may be provided as a service on an edge or cloud-computing network. As a non-limiting example, where the driving mode management system 104 may locally determine that the client device 102 should be engaged in a driving mode, the auto-response generation manager 112 may be implemented as a service (e.g., a cloud-native service) that generates and transmits an electronic message to another client device based on the client device 102 receiving a call while engaged in the driving mode and based on specific details of a driving mode configuration in effect on the client device 102. Other implementations may involve other components being implemented as services (e.g., microservices on a cloud computing system).

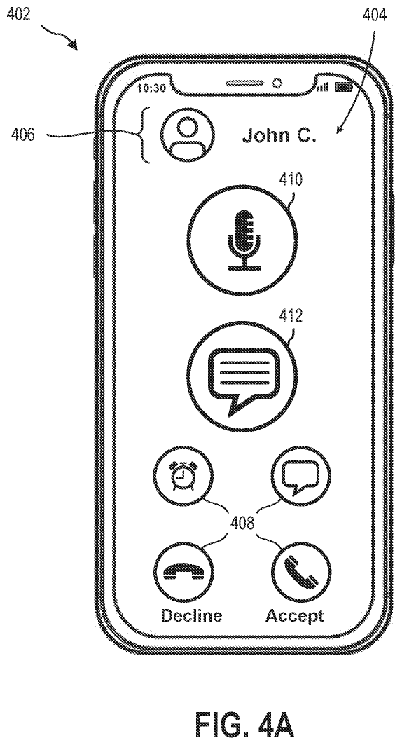

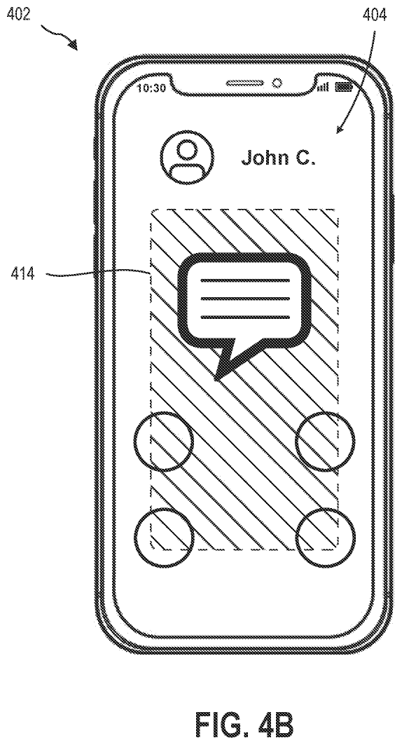

As shown in FIG. 2, the driving mode management system 104 may perform an act 210 of initiating a driving mode. Initiating a driving mode may be performed in a number of ways. As an example, in one or more embodiments, the driving mode management system 104 may provide an interface including a set of selectable options to toggle or manually set a status of a driving mode as “on” or “off.” (e.g., between an “on” state and an “off” state) As shown in FIG. 2, and as will be discussed further in connection with FIG. 4A-4B below, the driving mode management system 104 may provide a set of icons related to different modes, which a user may manually select to toggle a driving mode status of the client device 102 from an “off” state to an “on” state (or visa versa).

As further shown in FIG. 2, the driving mode management system 104 may perform an act 220 of determining whether to engage the driving mode. In particular, the driving mode management system 104 may determine whether to begin handling incoming communications as instructed by the driving mode configuration rather than in accordance with a default configuration of the client device 102. Fully engaging the driving mode may be performed based on a number of factors and determinations by the driving mode management system 104.

For example, in one or more embodiments, the driving mode management system 104 determines to engage the driving mode based on detecting a threshold movement of the client device 102 during a period that the driving mode has been initiated (e.g., during a period that the driving mode icon has been toggled to an “on” state). In one or more embodiments, detecting a threshold movement may involve determining that the client device 102 is moving at a certain velocity or rate of speed (e.g., based on locally tracked GPS data). In one or more embodiments, detecting a threshold movement may involve determining that the client device 102 is moving along a particular path, such as a path towards a known destination. In one or more implementations, the threshold movement is defined by information from the driving mode configuration (e.g., a threshold amount of movement, a threshold speed of movement, a threshold time over which movement is detected).

In one or more embodiments, the driving mode management system 104 determines to engage a driving mode based on movement of the client device 102 in accordance with a history of previous movements of the client device 102. For example, in one or more embodiments, the driving mode management system 104 may track a history of locations of the client device 102 and determine, based on the historical movements/locations, that the client device 102 is in transit to a predicted destination (e.g., work, home).

In one or more embodiments, the driving mode management system 104 may determine to engage the driving mode based on detected movement (e.g., while the driving mode icon has been toggled to “on”) and further based on additional information stored on the client device 102 with regard to location data for the user of the client device 102. For example, where a calendar application on the client device 102 may indicate a location and a corresponding time, and where the client device 102 is moving in a direction towards the location, the driving mode management system 104 may determine to engage the driving mode and handle calls in accordance with the driving mode configuration instructions.

In one or more embodiments, the driving mode management system 104 determines to engage a driving mode based on a user opening a navigation application on the client device 102. For instance, the driving mode management system 104 may determine based on a combination of a user selecting the driving mode icon and a navigation or map application running on the client device 102, the driving mode management system 104 is driving and the driving mode should be engaged. In this example, the navigation application may provide destination information including a location that the client device 102 is moving towards as well as an estimated time of arrival, which may correspond to an estimated time when the user is expected to be available to receive incoming calls.

In one or more embodiments, the acts 210 and 220 may be performed as part of a same act. For example, in one or more embodiments, the driving mode management system 104 may engage the driving mode based on the client device 102 being toggled to an “on” state and without detecting a threshold movement of the client device 102. Alternatively, in one or more embodiments, the driving mode may be engaged based on a detected movement of the client device indicative of the client device 102 being in transit, but without explicitly receiving an input toggling the driving mode to an “on” state. Indeed, it will be appreciated that the driving mode configuration may indicate any number of factors or combinations of signals that may cause the client device 102 to engage a driving mode.

As shown in FIG. 2, the driving mode management system 104 may perform an act 230 of receiving an incoming communication. The incoming communication may refer to any type of communication (e.g., voice communication, text communication) that is received at the client device 102 and originating from another client device. In one or more embodiments described herein, the incoming communication refers specifically to a voice communication. Nevertheless, features described in connection with receiving and responding to voice communications in accordance with the driving mode configuration instructions may similarly apply to responding to other types of communications.

In addition to simply detecting an incoming communication, in one or more embodiments, the driving mode management system 104 may determine that the incoming communication originates from a specific client device associated with a corresponding user. This determination of the source of the communication may be used in determining a specific set of actions to perform in handling the incoming call. For example, in one or more embodiments, the driving mode management system 104 may only invoke the driving mode instructions in handling the incoming communication where the communication originates from a known contact. Otherwise, the driving mode management system 104 may handle the incoming communication as it would handle any other call received while the client device 102 normally operates (e.g., not in a driving mode).

In one or more embodiments, the driving mode management system 104 may engage a different set of driving mode configuration instructions based on whether the communication originates from a known contact or not. For example, where the call originates from a known contact, the message generated in response to the call may include an indication of an estimated time of availability. In contrast, where the call originates from an unknown source, the message generated in response to the call may indicate unavailability, but not indicate an estimated time of availability in the auto-generated message.

In one or more embodiments described herein, the driving mode management system 104 may perform an act 240 of providing a display of a driving mode response icon (e.g., an interactive icon) in response to detecting the call while engaged in the driving mode. In one or more embodiments, the driving mode management system 104 provides an interactive icon (e.g., a selectable icon) in a center portion on a display area of the GUI. In one or more embodiments, the interactive icon covers some threshold portion of the display area (e.g., 10% or more) such that the interactive icon is larger than any other icon currently displayed on a GUI of the client device 102.

In one or more embodiments, the interactive icon is displayed over one or more existing icons on the GUI of the client device 102. In one or more embodiments, the interactive icon is displayed as an overlay such that any inputs (e.g., touch inputs) received at the corresponding area of the display screen interface is recognized as an input on the interactive icon rather than other icons displayed on the GUI of the client device 102 associated with other applications. In one or more embodiments, the driving mode management system 104 provides an overlay over an entire display area of the client device 102 such that any input received at any portion of the display area is detected as an interaction with the provided prompt icon. Additional examples will be discussed below in connection with further illustrated examples.

As used herein, the interactive icon may refer to any selectable input or displayed input that is presented via a display area of the client device 102. For example, an interactive icon may refer to any input that can be selected or actuated using a button, cursor, or object coming into contact with a GUI interface (e.g., a touchscreen interface) of the client device. By way of example, and as indicated in one or more examples described herein, an interactive icon may refer to a selectable button presented in conjunction with other inputs on a display area. In one or more embodiments, the interactive icon may refer to an overlay icon or an icon that is presented over one or more selectable icons on the display area such that an input detected on the interactive icon presented as part of the driving mode will be recognized over other inputs that would otherwise be presented at a similar location on the display area of the client device 102.

As shown in FIG. 2, the driving mode management system 104 may perform an act 250 of generating and transmitting a text message responsive to the incoming call. In one or more embodiments, the driving mode management system 104 generates and transmits the text message based on a detected selection of the prompt icon and based on the client device 102 being engaged in the driving mode. Alternatively, in one or more embodiments, the driving mode management system 104 generates and transmits the text message based on the client device 102 being engaged in the driving mode and without necessarily receiving a selection of the icon (e.g., such as an implementation when the prompt icon is not necessarily displayed).

As noted above, in one or more embodiments, the text message generated in response to the incoming communication includes a predetermined message in addition to an indication of a future availability (e.g., an estimated future availability) of the user to receive a subsequent voice communication. For example, the driving mode management system 104 may generate a text message with a default message or custom message (e.g., a message predetermined by a user of the client device 102) that is provided in response to an incoming call while the client device 102 is engaged in the driving mode. The driving mode management system 104 may further determine and include a predicted time of availability within the text message in addition to the default or custom message generated.

As discussed above, in one or more implementations described herein, the response message (e.g., the message generated in response to the incoming call while engaged in the driving mode) refers to a text message including predetermined text and an indicated time of estimated availability. Alternatively, in one or more embodiments, the response message may refer to a text message that is generated based on a translated audio message recorded by the client device 102 at a time when the incoming communication is received.

For example, in response to receiving an incoming communication and based on the client device 102 being engaged in the driving mode, the driving mode management system 104 may initiate recording of an audio message. For example, the user of the client device 102 may prompt recording of an audio message by providing a voice command while the client device 102 is accepting an incoming voice communication (e.g., while the client device 102 is ringing). In response to the prompt, the client device 102 may record a voice message and translate the voice input to a text input for generation of a text-based reply message. This enables the client device 102 respond to the incoming communication with a text message that is generated based on the recorded voice input. In one or more embodiments, as an alternative to a voice command, the client device 102 may begin recording a voice message based on selection of the interactive icon that is displayed in accordance with the driving mode configuration.

Each of the above features may be integrated into a normal call handling procedure of the client device 102. For example, where the client device 102 may be configured to allow some predetermined period of time (e.g., 10 seconds) for a user to answer an incoming call, this timing may correspond to instructions from the driving mode configuration with regard providing a display the interactive icon via the GUI of the client device 102.

For instance, if the user does not provide a voice command or does not select the interactive icon within the predetermined period of time, the driving mode management system 104 may perform any of a number of actions in accordance with the driving mode configuration. As an example, the driving mode management system 104 may cause the client device 102 to simply send the call to voicemail similar to a default configuration when the client device 102 is not engaged in the driving mode. As another example, the driving mode management system 104 may send a text message indicating the estimated availability and a canned message rather than allowing the user to provide a customized message based on a voice recording that is translated to a text message.

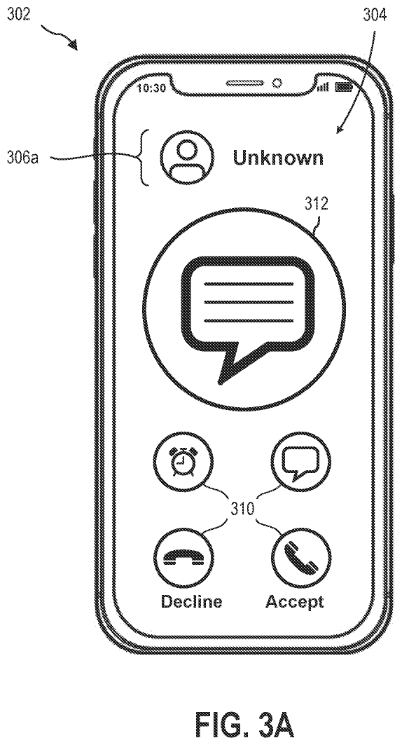

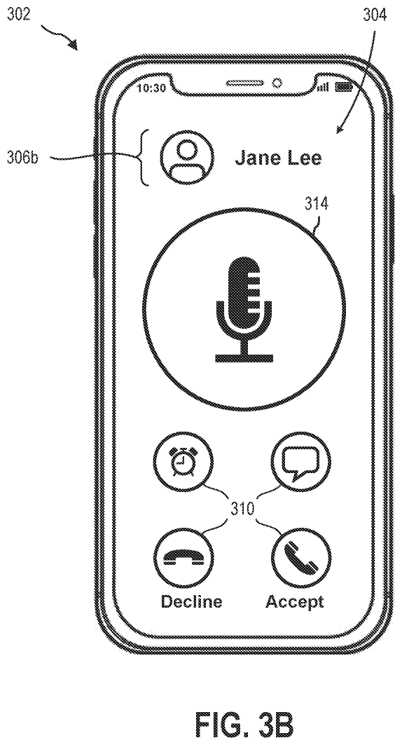

Additional information in connection with various examples and use-cases will be discussed now in connection with FIGS. 3A-4B. In particular, FIGS. 3A-3B illustrate example implementations in which the driving mode management system 104 may present interactive icons in connection with different text messages that may be generated and delivered in response to an incoming communication and based on a mobile device having engaged a driving mode. Moreover, as will be discussed in further detail below, FIGS. 4A-4B illustrate example implementations illustrating different examples of how the interactive icon may be presented via a GUI of a mobile device.

FIG. 3A illustrates an example implementation of a mobile device 302 having a graphical user face (GUI) 304 thereon. The mobile device 302 may be an example client device described in connection with any of the above-discussed examples. In this and other illustrated examples of mobile devices, the driving mode management system 104 may be implemented thereon and provide any of the features and functionalities described above in connection with one or more embodiments.

In this example, the driving mode management system 104 will have determined that the mobile device 302 has engaged a driving mode based on a combination of factors discussed above. For example, the driving mode management system 104 may trigger engagement of the driving mode based on detecting selection of a driving mode icon presented via a different GUI than the one illustrated in FIG. 3A (e.g., a settings application GUI, a home screen GUI, a lock screen GUI, etc.).

In the illustrated example, the driving mode management system 104 may causer the mobile device 302 to present any number of icons via the GUI 304 of the mobile device 302. For example, in FIG. 3A, the GUI 304 may include a presentation of a caller icon 306a. In this example, the caller icon 306a refers to an unknown caller (e.g., a user that is not included within a contact list accessible to the mobile device 302). As noted above, the driving mode management system 104 may invoke a different routine of a driving mode configuration based on whether the incoming caller is a known caller or not. In this example, the driving mode management system 104 may cause a driving mode response icon (e.g., a text message response icon 312) to be presented over a portion of the GUI 304 based on the mobile device 302 being engaged in a driving mode and the incoming communication originating from an unknown device. A text message response icon 312 may include similar features as examples described herein in connection with any interactive icon that prompts generation and/or delivery of a message to a sending device.

As noted above, the driving mode management system 104 may provide the text message response icon 312 to be presented in conjunction with additional icons 310 that are normally presented when handling incoming calls. This dual presentation of the text message response icon 312 in conjunction with the additional icons 310 enables the driving mode management system 104 to implement features of the driving mode without interrupting normal operation or instructions being executed by the mobile device 302.

As shown in FIG. 3A, the text message response icon 312 may appear as a larger icon than any of the additional icons 310 presently displayed via the GUI 304 of the mobile device 302. The specific size of the text message response icon 312 may differ between embodiments. In one or more embodiments, the text message response icon 312 may occupy at least 10% and as much as 100% of the displayable area of the GUI 304. In one or more embodiments, the driving mode response icon may simply be at least larger than any other selectable icon displayed via the GUI 304 of the mobile device 302.

Moving on, FIG. 3B illustrates another example implementation showing a presentation of a driving mode response icon (e.g., an audio-based response icon 314). Similar to the example shown in FIG. 3A, the mobile device 302 may include a GUI 304 presented thereon, which may include a number of interactive icons and data presented via the GUI 304. For example, the GUI 304 may include a caller icon 306b indicating that an incoming call is originating from a device associated with “Jane Lee.” In contrast to the example shown in FIG. 3A, the call may originate from a known device, which may prompt a different set of instructions from the driving mode configuration.

For example, in the illustrated configuration, the GUI 304 may include a audio-based response icon 314 presented in conjunction with additional icons 310. The additional icons 310 may include similar icons as those presented in FIG. 3A. Nevertheless, the audio-based response icon 314 may be presented based on the mobile device 302 being engaged in a driving mode in addition to the call originating from the device of a known contact.

It will be appreciated that the driving mode management system 104 may handle responding to an incoming call differently based on the different icons that are presented in FIGS. 3A and 3B. For example, in connection with FIG. 3A, in response to detecting a selection of the text message response icon 312, the driving mode management system 104 may generate and transmit a text message including a predetermined set of text in addition to an indication of a time of availability for a user of the mobile device 302 (e.g., to the originating device). Alternatively, in connection with FIG. 3B, in response to detecting a selection of the audio-based response icon 314, the driving mode management system 104 may initiate recording of a voice message, translate the voice message to a text message, and transmit the translated text message (e.g., to the originating device).

Moving on, FIG. 4A illustrates another example implementation showing a presentation of driving mode response icons that may be selected to prompt generation and transmission of a message to an originating device associated with an incoming call. As shown in FIG. 4A, a mobile device 402 may include a GUI 404 presented therein, which may include a number of icons presented within a display area of the mobile device 402. In this example, the GUI 404 may include a caller icon 406 indicating an identity of a caller associated with an incoming call. As further shown in FIG. 4A, the GUI 404 may include a plurality of icons 408 similar to the additional icons 310 discussed above in connection with FIGS. 3A-3B.

As further shown in FIG. 4A, the driving mode management system 104 may present multiple response icons associated with different driving mode responses. For example, the driving mode management system 104 may present a first response icon 410 that, when selected, prompts recording of a voice message, which can be translated to a text message prior to delivery to the originating device. This first response icon 410 may provide similar features as discussed above in connection with the audio-based response icon 314 illustrated in FIG. 3B.

As further shown in FIG. 4A, the driving mode management system 104 may present a second response icon 412. When the second response icon 412 is selected, the driving mode management system 104 may generate a text message in accordance with driving mode configuration instructions, similar to the description of the text message response icon 312 discussed above. For example, in response to detecting a selection of the second response icon 412, the driving mode management system 104 may generate a text message including a predetermined string of text and an indication of a predicted time that a user of the mobile device 402 will be available to receive calls.

FIG. 4B illustrates another example implementation showing the mobile device 402 having the GUI 404 presented thereon and including many of the same features as just discussed above in connection with FIG. 4A. In addition, FIG. 4B illustrates a presentation of an overlay icon 414 which may be displayed over a portion of the GUI 404. In this example, the overlay icon 414 is presented over a portion of additional icons that would otherwise be selectable when the mobile device 402 is not operating in the driving mode.

In this example, a user may select the overlay icon 414 by touching or otherwise interacting with the GUI 404 at nearly any location over the display area of the mobile device 402. This may include interacting with the overlay icon 414 at locations on the GUI 404 that would otherwise correspond to the additional icons associated with answering an incoming communication. Similar to one or more embodiments described herein, in response to detecting a selection of the overlay icon 414, the driving mode management system 104 may response to the incoming communication in accordance with any of the implementations described herein based on specific instructions of the driving mode configuration. For example, the driving mode management system 104 may generate and transmit a predetermined text message including an indicated time of availability for a user of the mobile device 402. In one or more embodiments, the driving mode management system 104 may record an audio message, translate the audio message, and transmit the translated audio message to an originating device.

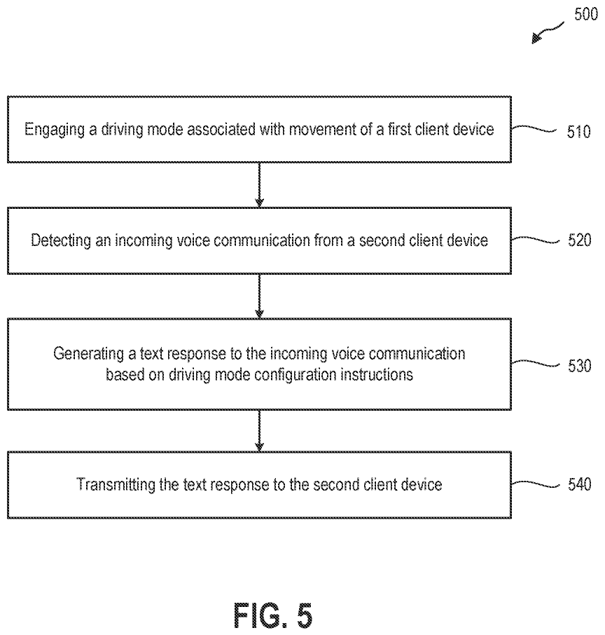

Turning now to FIG. 5, this figure illustrates example flowcharts including series of acts related to engaging a driving mode and processing an incoming communication while the client device is engaged in the driving mode. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device to perform the acts of FIG. 5. In still further embodiments, a system can perform the acts of FIG. 5.

As indicted above, FIG. 5 illustrates an example series of acts 500 related to engaging a driving mode and processing an incoming communication while the client device is engaged in the driving mode. As shown in FIG. 5, the series of acts 500 includes an act 510 of engaging a driving mode associated with movement of a first client device. For example, in one or more embodiments, the act 510 involves engaging, by the first client device, a driving mode associated with an estimated movement of the first client device over a period of time, the driving mode being associated with a driving mode configuration including a set of instructions for responding to incoming communications while engaged in the driving mode.

As further shown in FIG. 5, the series of acts 500 may include an act 520 of detecting an incoming voice communication from a second client device. For example, in one or more embodiments, the act 520 involves detecting, by the first client device, an incoming voice communication from a second client device.

As further shown in FIG. 5, the series of acts 500 may include an act 530 of generating a text response to the incoming voice communication based on driving mode configuration instructions. For example, in one or more embodiments, the act 530 involves causing a text response to be generated responsive to the incoming voice communication based on the set of instructions from the driving mode configuration and based on the first client device being engaged in the driving mode.

As further shown in FIG. 5, the series of acts 500 may include an act 540 of transmitting the text response to the second client device. For example, in one or more embodiments, the act 540 may include causing the text response to be transmitted to the second client device. In one or more embodiments, the text response is generated or transmitted by a service accessible to the first client device via a fifth generation (5G) network architecture. For example, the text response may be transmitted via a 5G network architecture. Alternatively, in one or more embodiments, the text response may be generated and/or transmitted by a cloud-based service on a cloud-computing platform that the first client device is connected to via the 5G network.

In one or more embodiments, the series of acts 500 further includes detecting a user selection of a driving mode icon from an off state to an on state, the driving mode icon being provided via a display of the first client device. In one or more implementations, engaging the driving mode is based on detecting the user selection of the driving mode icon.

In one or more embodiments, the series of acts 500 further includes detecting a threshold movement of the first client device, the threshold movement of the first client device being defined by the driving mode configuration. In one or more implementations, engaging the driving mode is further based on detecting the threshold movement of the first client device. In one or more embodiments, the series of acts 500 further includes detecting that a navigation application is running on the first client device or on a service accessible via a 5G network. In one or more implementations, engaging the driving mode is further based on detecting that the navigation application is running on the first client device or on the service accessible via the 5G network.

In one or more embodiments, the series of acts 500 includes determining that the second client device is associated with a known contact stored on the first client device. In one or more implementations, causing the text response to be generated is further based on determining that the second client device associated with the incoming voice communication is associated with the known contact.

In one or more embodiments, the series of acts 500 includes presenting, via a graphical user interface of the first client device, a driving mode response icon. In this example, causing the text response to be generated may be based on detecting a user selection of the driving mode response icon. In one or more embodiments, the driving mode response icon is an overlay icon displayed over at least a portion of the graphical user interface of the first client device. In one or more implementations, the driving mode response icon is a largest selectable icon displayed on the graphical user interface of the first client device.

In one or more embodiments, the series of acts 500 includes determining an estimated time of availability of a user of the first client device when the user of the first client device is predicted to be available to receive voice communications from the second client device. In one or more embodiments, the series of acts 500 includes, in response to detecting the selection of the driving mode response icon, populating the text response with a pre-composed text portion and an indication of the estimated time of availability of the user of the first client device. In one or more embodiments, determining the estimated time of available is based on an expected time of arrival between a current position of the first client device and a predicted target destination of the first client device.

In one or more embodiments, the series of acts 500 includes, in response to detecting the selection of the driving mode response icon, initiating a recording of a voice message received via an audio recording device on the first client device. The series of acts 500 may further include converting the recording of the voice message to a text message. In one or more implementations, causing the text response to be generated includes populating the text response to the incoming voice communication with the text message converted from the voice message. In one or more embodiments, the text response is transmitted to the second client device via a fifth generation (5G) network architecture.

In one or more embodiments, the driving mode response icon is provided for a predetermined period of time based on a predetermined timing of the first client device associated with routing incoming voice communications to voice mail. In one or more implementations, causing the text response to be generated only occurs when the driving mode response icon is selected within the predetermined timing.

In one or more embodiments, the driving mode icon can be selected in one of a number of ways. For example, in one or more implementations, the driving mode response icon is selected by detecting a touch input on a touchscreen of the first client device at a location on the graphical user interface corresponding to a location of a display of the driving mode response icon. In addition, or as an alternative, the driving mode response icon may be selected by detecting an audio input from a user of the first client device, the audio input including a voice command pre-associated with selecting the driving mode response icon.

FIG. 6 illustrates certain components that may be included within a computer system 600. One or more computer systems 600 may be used to implement the various devices, components, and systems described herein.

The computer system 600 includes a processor 601. The processor 601 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used. In one or more embodiments, the computer system 600 further includes one or more graphics processing units (GPUs), which can provide processing services related to both entity classification and graph generation.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular datatypes, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for responding to incoming communications to a first client device in a transit environment, the method comprising:
engaging, by the first client device, a driving mode associated with an estimated movement of the first client device over a period of time, the driving mode being associated with a driving mode configuration including a set of instructions for responding to incoming communications while engaged in the driving mode;
detecting, by the first client device, an incoming voice communication from a second client device;
causing a text response to be generated responsive to the incoming voice communication based on the set of instructions from the driving mode configuration and based on the first client device being engaged in the driving mode; and
causing the text response to be transmitted to the second client device.

2. The method of claim 1, further comprising detecting a user selection of a driving mode icon from an off state to an on state, the driving mode icon being provided via a display of the first client device, and wherein engaging the driving mode is based on detecting the user selection of the driving mode icon.

3. The method of claim 2, further comprising detecting a threshold movement of the first client device, the threshold movement of the first client device being defined by the driving mode configuration, and wherein engaging the driving mode is further based on detecting the threshold movement of the first client device.

4. The method of claim 2, further comprising detecting that a navigation application is running on the first client device or on a service accessible via a fifth generation (5G) network, wherein engaging the driving mode is further based on detecting that the navigation application is running on the first client device or on the service accessible via the 5G network.

5. The method of claim 1, further comprising determining that the second client device is associated with a known contact stored on the first client device, wherein causing the text response to be generated is based on determining that the second client device associated with the incoming voice communication is associated with the known contact.

6. The method of claim 1, further comprising providing, via a graphical user interface of the first client device, a driving mode response icon, wherein causing the text response to be generated is based on detecting a user selection of the driving mode response icon.

7. The method of claim 6, wherein the driving mode response icon is an overlay icon displayed over at least a portion of the graphical user interface of the first client device, and wherein the driving mode response icon is a largest selectable icon displayed on the graphical user interface of the first client device.

8. The method of claim 6, further comprising:
determining an estimated time of availability of a user of the first client device when the user of the first client device is predicted to be available to receive voice communications from the second client device; and
in response to detecting the selection of the driving mode response icon, populating the text response with a pre-composed text portion and an indication of the estimated time of availability of the user of the first client device.

9. The method of claim 8, wherein determining the estimated time of available is based on an expected time of arrival between a current position of the first client device and a predicted target destination of the first client device.

10. The method of claim 6, further comprising:
in response to detecting the selection of the driving mode response icon, initiating a recording of a voice message received via an audio recording device on the first client device; and
converting the recording of the voice message to a text message,
wherein causing the text response to be generated includes populating the text response to the incoming voice communication with the text message converted from the voice message, and
wherein the text response is transmitted to the second client device via a fifth generation (5G) network architecture.

11. The method of claim 6, wherein the driving mode response icon is provided for a predetermined period of time based on a predetermined timing of the first client device associated with routing incoming voice communications to voice mail, and wherein causing the text response to be generated only occurs when the driving mode response icon is selected within the predetermined timing.

12. The method of claim 6, wherein the driving mode response icon is selectable by one or more of:
detecting a touch input on a touchscreen of the first client device at a location on the graphical user interface corresponding to a location of a display of the driving mode response icon; or
detecting an audio input from a user of the first client device, the audio input including a voice command pre-associated with selecting the driving mode response icon.

13. The method of claim 1, wherein the text response is generated or transmitted by a service accessible to the first client device via a fifth generation (5G) network architecture.

14. A system, comprising:
at least one processor;
memory in electronic communication with the at least one processor; and
instructions stored in the memory, the instructions being executable by the at least one processor to:
engage, by a first client device, a driving mode associated with an estimated movement of the first client device over a period of time, the driving mode being associated with a driving mode configuration including a set of instructions for responding to incoming communications while engaged in the driving mode;
detect, by the first client device, an incoming voice communication from a second client device;
generate a text response to the incoming voice communication based on the set of instructions from the driving mode configuration and based on the first client device being engaged in the driving mode; and
transmit the text response to the second client device.

15. The system of claim 14, wherein the instructions are further executable by the at least one processor to detect a user selection of a driving mode icon from an off state to an on state, the driving mode icon being provided via a display of the first client device, and wherein engaging the driving mode is based on detecting the user selection of the driving mode icon.

16. The system of claim 15, wherein the instructions are further executable by the at least one processor to detect a threshold movement of the first client device, the threshold movement of the first client device being defined by the driving mode configuration, and wherein engaging the driving mode is further based on detecting the threshold movement of the first client device.

17. The system of claim 14, wherein the instructions are further executable by the at least one processor to:
provide, via a graphical user interface of the first client device, a driving mode response icon;
in response to detecting a selection of the driving mode response icon, initiate a recording of a voice message received via an audio recording device on the first client device; and
convert the recording of the voice message to a text message,
wherein generating the text response includes populating the text response to the incoming voice communication with the text message converted from the voice message, and
wherein the text response is transmitted to the second client device via a fifth generation (5G) network architecture.

18. A non-transitory computer readable storage medium storing instructions thereon that, when executed by at least one processor, causes a first client device to:
engage, by a first client device, a driving mode associated with an estimated movement of the first client device over a period of time, the driving mode being associated with a driving mode configuration including a set of instructions for responding to incoming communications while engaged in the driving mode;
detect, by the first client device, an incoming voice communication from a second client device;
generate a text response to the incoming voice communication based on the set of instructions from the driving mode configuration and based on the first client device being engaged in the driving mode; and
transmit the text response to the second client device.

19. The non-transitory computer readable storage medium of claim 18, further comprising instructions that, when executed by the at least one processor, cause the first client device to:
detect a user selection of a driving mode icon from an off state to an on state, the driving mode icon being provided via a display of the first client device; and
detect a threshold movement of the first client device, the threshold movement of the first client device being defined by the driving mode configuration,
wherein engaging the driving mode is based on detecting the user selection of the driving mode icon and detecting the threshold movement of the first client device.

20. The non-transitory computer readable storage medium of claim 18, further comprising instructions that, when executed by the at least one processor, cause the first client device to:
provide, via a graphical user interface of the first client device, a driving mode response icon;
in response to detecting a selection of the driving mode response icon, initiate a recording of a voice message received via an audio recording device on the first client device; and
convert the recording of the voice message to a text message,
wherein generating the text response includes populating the text response to the incoming voice communication with the text message converted from the voice message.
